(19) United States
(12) Patent Application Publication
(10) Pub. No.: US 2005/0086531 A1
(43) Pub. Date: Apr. 21, 2005

(54) Method and system for proxy approval of security changes for a file security system

(75) Inventor: Michael Frederick Kenrich, Aptos, CA (US)

Correspondence Address: BEYER WEAVER & THOMAS LLP, P.O. BOX 70250, OAKLAND, CA, 94612-0250, US

(73) Assignee: PSS Systems, Inc.

(21) Appl. No.: 10/690,243

(22) Filed: Oct. 20, 2003

(51) Int. Cl. G06F 11/30; G06F 12/14

(52) U.S. Cl. 713/201; 713/165; 707/9

(57) ABSTRACT

A system and method for providing a file security system with an approval process to implement security changes are disclosed. The approval process can be substantially automated as well as configurable and/or flexible. The approval process can make use of a set of approvers that can approve or deny a security change. Different security changes can require the approval of different approvers. The approvers can also be arranged into groups of approvers, and such groups can make use of a hierarchical arrangement.

### CROSS-REFERENCE TO RELATED APPLICATIONS

This application is related to: (i) U. S. patent application Ser. No. ______ [attorney docket no. SSL1P020], filed Sep. 30, 2003, and entitled “METHOD AND SYSTEM FOR SECURING DIGITAL ASSETS USING PROCESS-DRIVEN SECURITY POLICIES,” which is hereby incorporated by reference for all purposes; (ii) U. S. patent application Ser. No. ______, [attorney docket no. SSL1P021], filed Sep. 30, 2003, and entitled “METHOD AND APPARATUS FOR TRANSITIONING BETWEEN STATES OF SECURITY POLICIES USED TO SECURE ELECTRONIC DOCUMENTS,” which is hereby incorporated by reference for all purposes; (iii) U.S. patent application Ser. No. 10/262,218, filed Sep. 30, 2002, and entitled “DOCUMENT SECURITY SYSTEM THAT PERMITS EXTERNAL USERS TO GAIN ACCESS TO SECURED FILES,” which is hereby incorporated by reference for all purposes; (iv) U.S. patent application Ser. No. 10/075,194, filed Feb. 12, 2002, and entitled “SYSTEM AND METHOD FOR PROVIDING MULTI-LOCATION ACCESS MANAGEMENT TO SECURED ITEMS,” which is hereby incorporated by reference for all purposes; (v) U.S. patent application Ser. No.: 10/159,537, filed May 5, 2002, and entitled “METHOD AND APPARATUS FOR SECURING DIGITAL ASSETS,” which is hereby incorporated herein by reference; and (vi) U.S. patent application Ser. No.: 10/127,109, filed Apr. 22, 2002, and entitled “EVALUATION OF ACCESS RIGHTS TO SECURED DIGITAL ASSETS,” which is hereby incorporated herein by reference.

### BACKGROUND OF THE INVENTION

1. Field of the Invention

The present invention relates to security systems for data and, more particularly, to security systems that protect data in an inter/intra enterprise environment.

2. Description of Related Art

The Internet is the fastest growing telecommunications medium in history. This growth and the easy access it affords have significantly enhanced the opportunity to use advanced information technology for both the public and private sectors. It provides unprecedented opportunities for interaction and data sharing among businesses and individuals. However, the advantages provided by the Internet come with a significantly greater element of risk to the confidentiality and integrity of information. The Internet is an open, public and international network of interconnected computers and electronic devices. Without proper security means, an unauthorized person or machine may intercept information traveling across the Internet and even gain access to proprietary information stored in computers that interconnect to the Internet.

There are many efforts in progress aimed at protecting proprietary information traveling across the Internet and controlling access to computers carrying the proprietary information. Cryptography allows people to carry over the confidence found in the physical world to the electronic world, thus allowing people to do business electronically without worries of deceit and deception. Every day millions of people interact electronically, whether it is through e-mail, e-commerce (business conducted over the Internet), ATM machines, or cellular phones. The perpetual increase of information transmitted electronically has led to an increased reliance on cryptography.

One of the ongoing efforts in protecting the proprietary information traveling across the Internet is to use one or more cryptographic techniques to secure a private communication session between two communicating computers on the Internet. The cryptographic techniques provide a way to transmit information across an unsecure communication channel without disclosing the contents of the information to anyone eavesdropping on the communication channel. Using an encryption process in a cryptographic technique, one party can protect the contents of the data in transit from access by an unauthorized third party, yet the intended party can read the encrypted data after using a corresponding decryption process.

A firewall is another security measure that protects the resources of a private network from users of other networks. However, it has been reported that many unauthorized accesses to proprietary information occur from the inside, as opposed to from the outside. An example of someone gaining unauthorized access from the inside is when restricted or proprietary information is accessed by someone within an organization who is not supposed to do so. Due to the open nature of networks, contractual information, customer data, executive communications, product specifications, and a host of other confidential and proprietary intellectual property remain available and vulnerable to improper access and usage by unauthorized users within or outside a supposedly protected perimeter.

Many businesses and organizations have been looking for effective ways to protect their proprietary information. Typically, businesses and organizations have deployed firewalls, Virtual Private Networks (VPNs), and Intrusion Detection Systems (IDS) to provide protection. Unfortunately, these various security means have been proven insufficient to reliably protect proprietary information residing on private networks. For example, depending on passwords to access sensitive documents from within often causes security breaches when the password of a few characters long is leaked or detected. Consequently, various cryptographic means are deployed to provide restricted access to electronic data in security systems.

As previously noted, security systems can operate to restrict access to data (e.g., files). Typically, the data is provided in an electronic file and stored in an encrypted fashion so that only authorized users can gain access to such files. The security system operates in accordance with security system information. The security system information can, for example, pertain to adding or dropping a user from the security system. Conventionally, upon receiving a request to add or drop a user, a system administrator would communicate with the security system to implement the requested changes, assuming the system administrator approved the changes. Unfortunately, however, a user of the security system may request to add or drop a user to the security system while the administrator is busy, away from her office, or otherwise unavailable. In such cases, the requested change to add or drop the user to the security system cannot be approved and, as a result, cannot be implemented. Consequently, the user seeking the change to the security system information is often significantly delayed and frustrated while awaiting approval of a system administrator.

Therefore, there is a need to provide more effective ways for security systems to permit changes to be approved.

### SUMMARY OF THE INVENTION

The invention pertains to a system and method for providing a file security system with an approval process to implement security changes. The approval process can be substantially automated as well as configurable and/or flexible. The approval process can make use of a set of approvers that can approve or deny a security change. Different security changes can require the approval of different approvers. The approvers can also be arranged into groups of approvers, and such groups can make use of a hierarchical arrangement.

The invention can be implemented in numerous ways, including as a method, system, apparatus, and computer readable medium. Several embodiments of the invention are discussed below.

As a method for approving a security change for a file security system that secures electronic files, one embodiment of the invention includes at least the acts of: receiving a requested security change from a requestor; identifying a plurality of approvers to approve or disapprove of the requested security change; notifying the approvers of an approval request for the requested security change; determining whether the requested security change is approved based on responses from the approvers to the approval request; and performing the requested security change when it is determined that the requested security change has been approved.

As a file security system that restricts access to secured electronic documents, one embodiment of the invention includes at least: an access server that restricts access to the secured electronic documents; and an approval manager operatively connected to the access server. The approval manager operates a security change approval process to determine whether a requested security change is approved.

As a computer readable medium including at least computer program code for approving a security change for a file security system that secures electronic files, one embodiment of the invention includes at least: computer program code for notifying a plurality of approvers of an approval request for the requested security change; computer program code for determining whether the requested security change is approved based on responses from the approvers to the approval request; and computer program code for performing the requested security change when it is determined that the requested security change has been approved.

Other objects, features, and advantages of the present invention will become apparent upon examining the following detailed description of an embodiment thereof, taken in conjunction with the attached drawings.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is a computer system according to one embodiment of the invention.

FIG. 2 is a diagram of a file security system according to one embodiment of the invention.

FIG. 3 is a flow diagram of a security proxy process according to one embodiment of the invention.

FIGS. 4A and 4B are flow diagrams of a security change approval process according to one embodiment of the invention.

FIGS. 5A and 5B are flow diagrams of an approval set process according to one embodiment of the invention.

FIG. 6 is a flow diagram of an approval group process according to one embodiment of the invention.

FIG. 7 is a flow diagram of an approval hierarchy process according to one embodiment of the invention.

### DETAILED DESCRIPTION OF THE INVENTION

The invention pertains to a system and method for providing a file security system with an approval process to implement security changes. The approval process can be substantially automated as well as configurable and/or flexible. The approval process can make use of a set of approvers that can approve or deny a security change. Different security changes can require the approval of different approvers. The approvers can also be arranged into groups of approvers, and such groups can make use of a hierarchical arrangement.

A file security system (or document security system) serves to limit access to files (documents) to authorized users. Often, an organization, such as a company, would use a file security system to limit access to its files (documents). For example, users of a group might be able to access files (documents) pertaining to the group, whereas other users not within the group would not be able to access such files (documents). Such access, when permitted, would allow a user of the group to retrieve a copy of the file (document) via a data network.

Secured files are files that require one or more keys, passwords, access privileges, etc. to gain access to their content. According to one aspect of the invention, the security is provided through encryption and access rules. The files, for example, can pertain to documents, multimedia files, data, executable code, images and text. In general, a secured file can only be accessed by authenticated users with appropriate access rights or privileges. In one embodiment, each secured file is provided with a header portion and a data portion, where the header portion contains or points to security information. The security information is used to determine whether access to associated data portions of secured files is permitted.

In the following description, numerous specific details are set forth in order to provide a thorough understanding of the invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations to the invention.

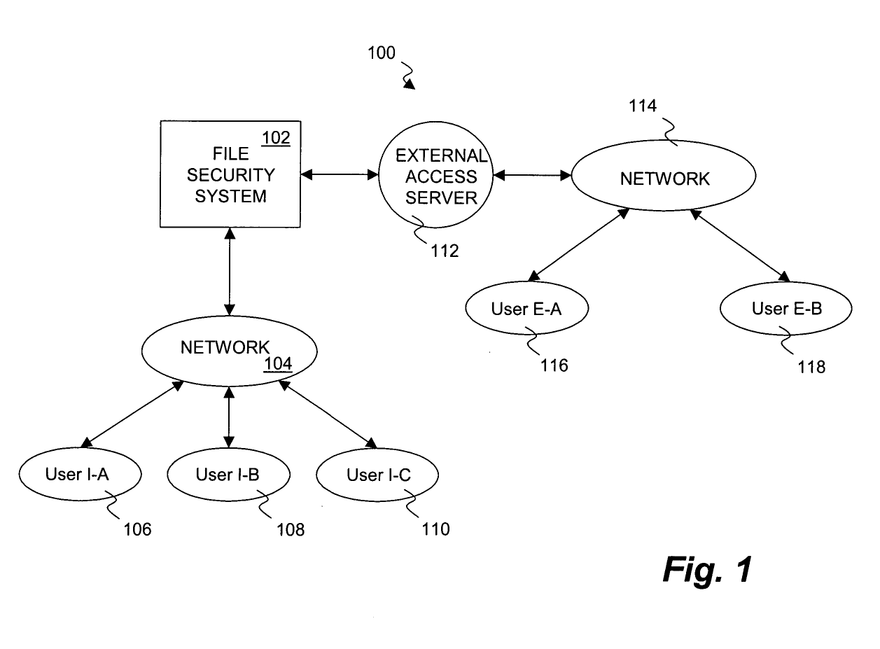

Embodiments of the present invention are discussed herein with reference to FIGS. 1-7. However, those skilled in the art will readily appreciate that the detailed description given herein with respect to these figures is for explanatory purposes as the invention extends beyond these limited embodiments.

FIG. 1 is a computer system 100 according to one embodiment of the invention. The computer system 100 includes a file security system 102 that is responsible for providing protection of electronic data for an organization. More specifically, the file security system 102 restricts access to electronic files. The file security system 102 is coupled to a network 104. The network 104 is, in one embodiment, a private network. A plurality of users can access the file security system 102 via the network 104. The plurality of internal users can be represented by user I-A 106, user I-B 108 and user I-C 110 illustrated in FIG. 1. The electronic files being protected by the file security system 102 can be stored centrally at the file security system 102 or locally at computer systems associated with the users 106-110.

The computer system 100 can further include an external access server 112. The external access server 112 can couple to the file security system 102 so as to enable remote users to have limited access to electronic files secured by the file security system. The external access server 112 can also couple to a network 114. A plurality of external users, namely, user E-A 116 and user E-B 118, can communicate with the external access server 112 via the network 114.

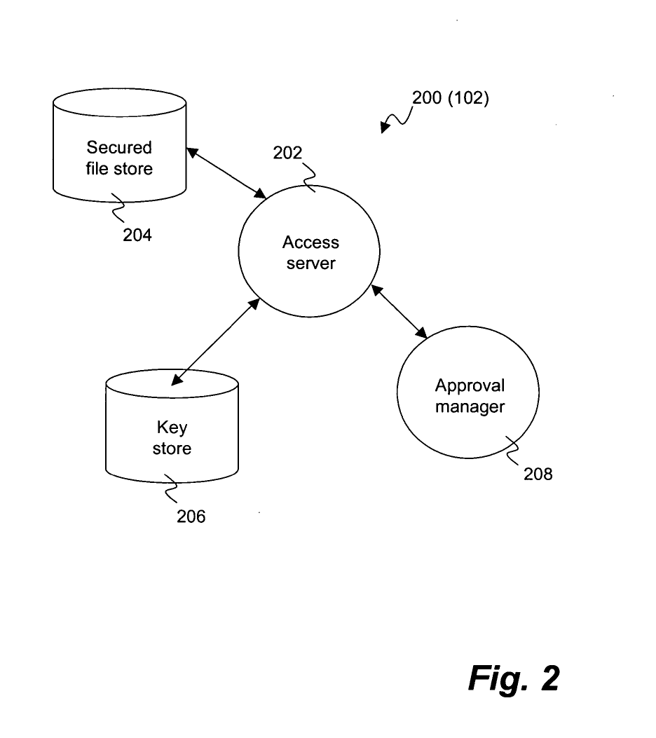

FIG. 2 is a diagram of a file security system 200 according to one embodiment of the invention. The file security system 200 is, for example, suitable for use as one embodiment of the file security system 102 illustrated in FIG. 1. The file security system 200 includes an access server 202, a secure file store 204, a key store 206, and an approval manager 208. The access server 202 imposes restrictions on access to secured files that are stored centrally or locally. Users, e.g., operating client modules, can access the access server 202 to retrieve cryptographic keys (i.e., private and public key pairs) from the key store 206 and/or electronic files from the secured file store 204. In one embodiment, the key store 206 can be implemented in a database that stores key pairs (among other things). The access server 202 can also be assisted by local servers (not shown) which can provide distributed access control. Various internal users within an organization that is utilizing the file security system 200 interact with the access server 202 and/or one of the local servers. These internal users are represented by users 106-110 in FIG. 1.

By interacting with the access server 202, authorized users are able to gain access to electronic files that are secured by the file security system 200. The approval manager 208 serves to operate an approval process that is used to determine whether a requested security change to be made is approved. The type of requested security change can vary, but examples include adding, modifying or deleting a user with respect to the file security system 200. Other examples of requested security changes include alterations to access restrictions on secured files (e.g., who has access to a file or when/how the file is retained). When the approval manager 208 determines that the requested security change is approved, then the access server 202 can implement the requested security change. On the other hand, when the approval manager 208 determines that the requested security change has not been approved, then the access server 202 does not perform the requested security change. The approval process that is managed by the approval manager 208 is largely automated, though one or more approvers are utilized as part of the approval process. In other words, the approval manager 208 or the approval process, can also be referred to as a security approval proxy. The approval process is advantageously not dependent upon one or a few security administrators to enable a file security system to invoke requested security changes. Instead, certain users of the file security system can be deemed “approvers” and participate in the approval process in a substantially automated manner. The specifics of the approval process can vary with implementation.

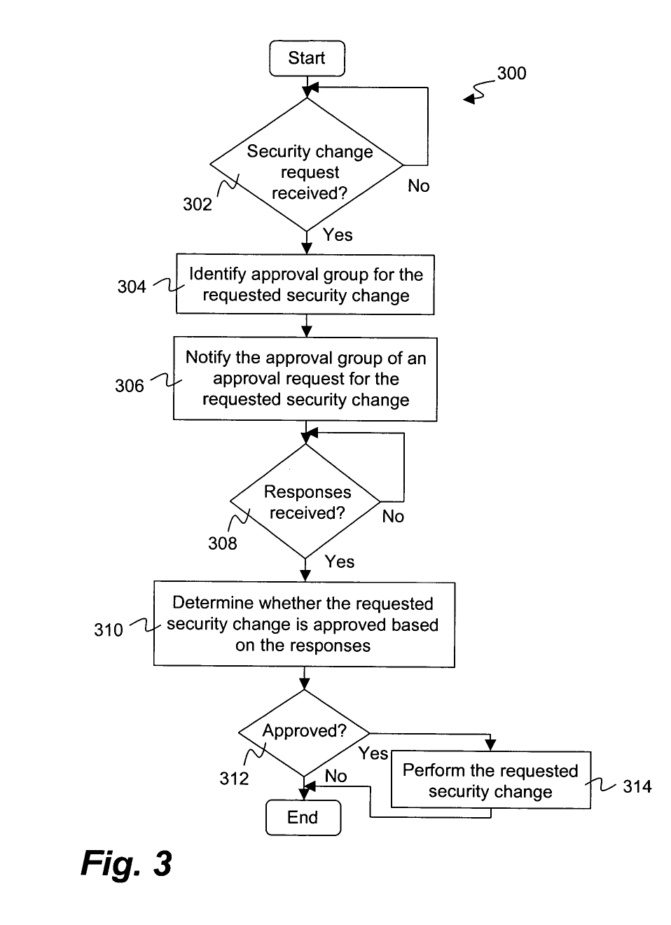

FIG. 3 is a flow diagram of a security proxy process 300 according to one embodiment of the invention. The security proxy process 300 is, for example, performed by an approval manager, such as the approval manager 208 illustrated in FIG. 2.

The security proxy process 300 begins with a decision 302 that determines whether a security change request has been received. When the decision 302 determines that a security change request has not yet been received, the security proxy process 300 awaits such a request. The security proxy process 300 continues once a security change request is received. In other words, the security proxy process 300 can be invoked when a security change request is received.

In any case, after a security change request has been received, an approval group for the requested security change is identified 304. The approval group includes one or more approvers for the file security system. Typically, the approvers are users of the file security systems that are chosen to participate in the approval process. The approval group is then notified 306 of an approval request for the requested security change. The approval request asks the users within the approval group to either approve or deny the requested security change. After the approval group is notified 306 of the approval request, a decision 308 determines whether at least one response to the approval request has been received from the approval group. When the decision 308 determines that a response has not yet been received, the security proxy process 300 awaits such responses. In one embodiment, the decision 308 would cause the security proxy process 300 to await a response from at least a predetermined number of the members of the approval group. In an alternative embodiment, the decision 308 would cause the security proxy process 300 to wait for a response for a limited amount of time, thus denying the requested security change if a suitable number of responses are not received in a timely manner.

After the decision 308 determines that a responses has been received (or a limited amount of time has been exceeded), then the security proxy process 300 determines 310 whether the requested security change is approved based on the responses. Next, a decision 312 determines whether the requested security change has been approved. When the decision 312 determines that the requested security change has been approved by the approval group, then the requested security change can be performed 314. Here, the requested security change is implemented as requested by the requestor. On the other hand, when the decision 312 determines that that the requested security change was not approved by the approval group, then the requested security change is not performed. Hence, following the decision 312 when the requested security change is not performed (as well as following the block 314 when the requested security change has been performed), the security proxy process 300 is complete and ends.

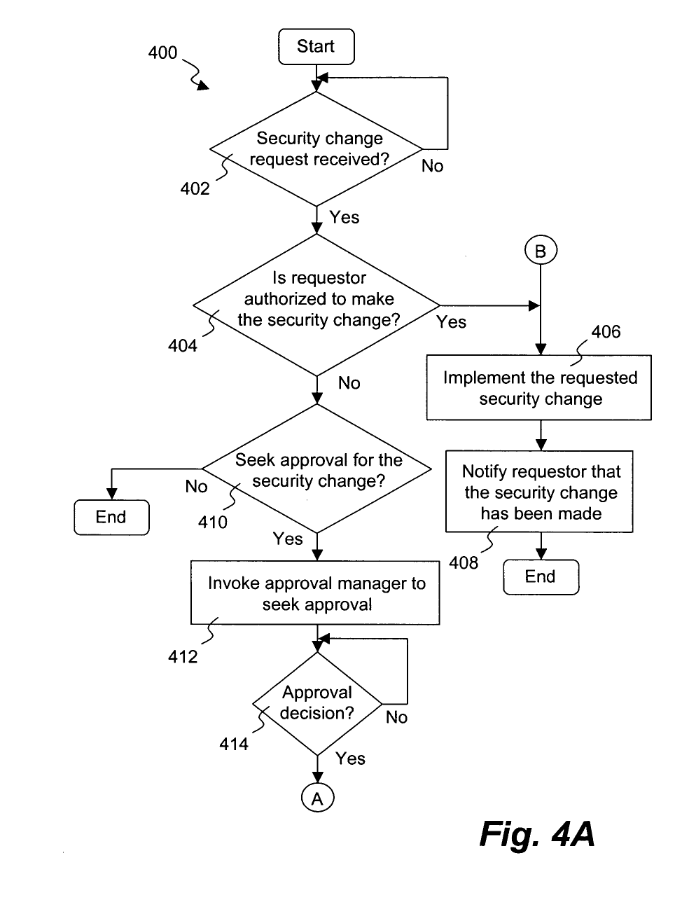

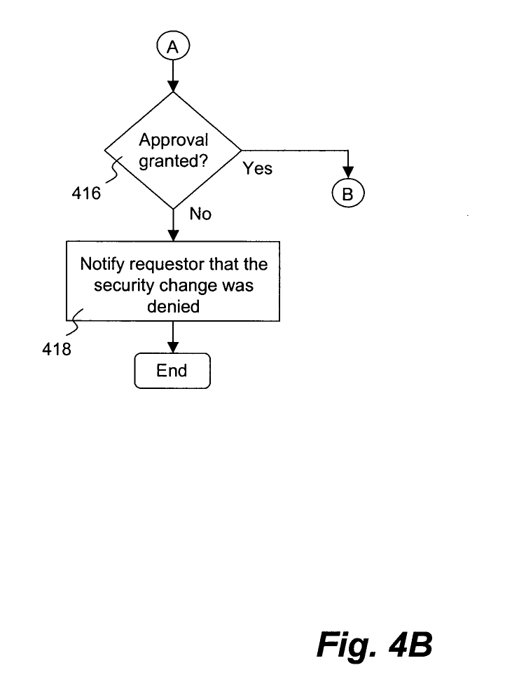

FIGS. 4A and 4B are flow diagrams of a security change approval process 400 according to one embodiment of the invention. The security change approval process 400 is, for example, performed by an approval manager, such as the approval manager 208 illustrated in FIG. 2.

The security change approval process 400 begins with a decision 402 that determines whether a security change request has been received. When the decision 402 determines that a security change request has not yet been received, the security change approval process 400 awaits such a request. Once the decision 402 determines that a security change request has been received, the security change approval process 400 continues. In other words, the security change approval process 400 can be invoked once a security change request has been received. After a security change request has been received, a decision 404 determines whether the requestor is authorized to make the security change that is being requested.

When the decision 404 determines that the requestor is authorized to make the security change, then the requested security change can be implemented 406. In this case, the requested security change does not require a security approval proxy. As a result, the requestor himself can cause the requested security change to be implemented 406. For example, in one implementation, the requested security change that does not require a security approval proxy is a change that is minor or low-level. Following the block 406, the requestor is notified 408 that the security change has been made. Following the block 408 the security change approval process 400 is complete and ends with the requested security change having been made.

On the other hand, when the decision 404 determines that the requestor is not authorized to make the security change, then a decision 410 determines whether the requester desires to seek approval for the security change. Here, it is assumed that the security change approval process 400 has, for this requested security change, one or more approvers that can be summoned to approve or deny the requested security change. The requester can then be queried as to whether they desire to seek approval for the security change, knowing that they themselves are not authorized to make the change. When the decision 410 determines that the requestor does not want to seek approval for the security change, then the security change approval process 400 is complete and ends.

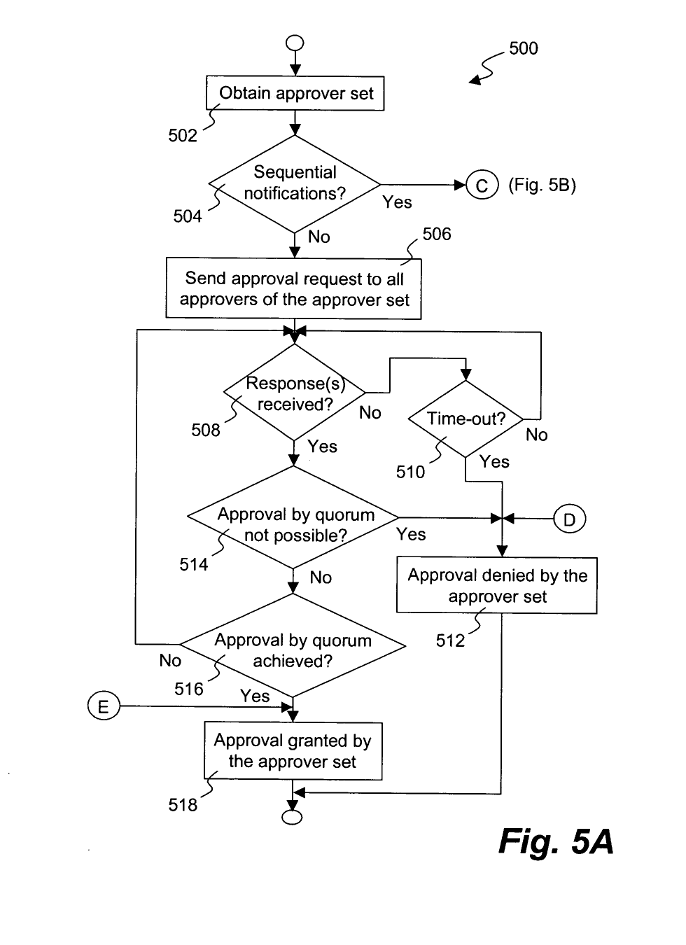

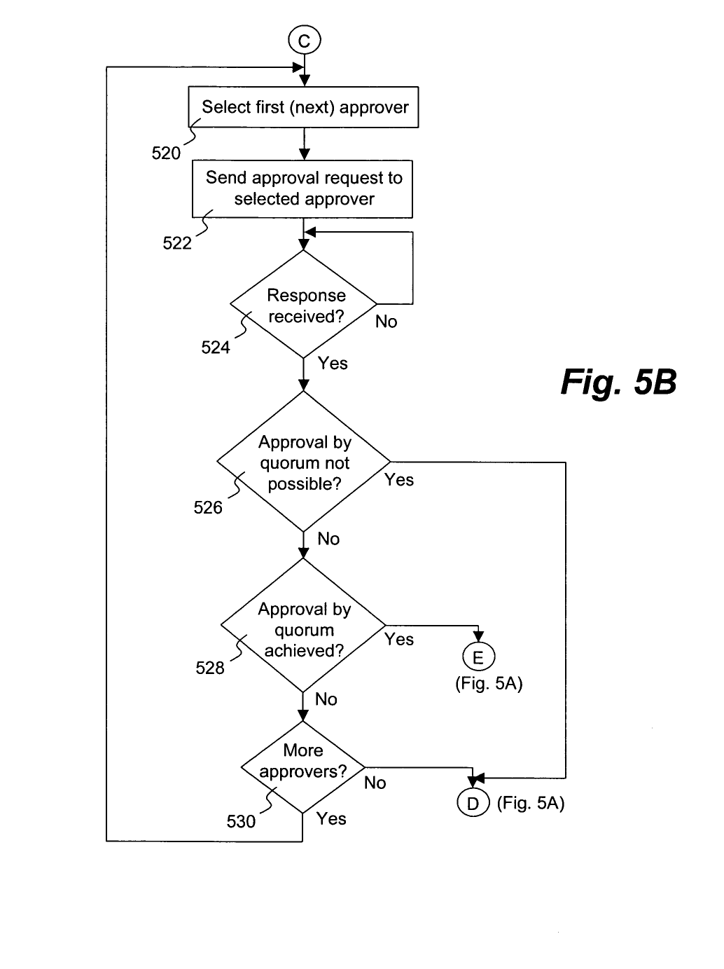

Alternatively, when the decision 410 determines that the requestor does desire to seek approval for the requested security change, then an approval manager is invoked 412 to seek approval. As an example, the approval manager can be implemented by the approval manager 208 illustrated in FIG. 2. In general, the approval manager notifies one or more approvers of the requested security change being requested by the requestor. The one or more approvers then respond to the approval manager with an indication of whether they approve or disapprove of the requested security change. The approval manager can then make an approval decision. Additional details on processing of approval requests by the approval manager are described below with respect to FIGS. 5A-7.

Next, a decision 414 determines whether an approval decision has been made. Here, the approval decision would be made by the approval manager. When the decision 414 determines that the approval manager has not yet made an approval decision, the security change approval process 400 can wait for an approval decision. Once the decision 414 determines that an approval decision has been made, a decision 416 determines whether the approval has been granted. When the decision 416 determines that the approval has been granted, then the security change approval process 400 proceeds to the blocks 406 and 408 where the requested security change can be implemented and the requestor notified. On the other hand, when the decision 416 determines that approval has not been granted (approval denied), then the requestor is notified 418 that the requested security change has been denied. In this case, the requested security change is not implemented. Following the block 418, the security change approval process 400 is complete and ends.

Fundamentally, approval of security changes can be determined by approvers. These approvers can be arranged into approver sets and the approver sets can be arranged into approver groups. Further, not all of the approvers within a set need to unanimously agree as to the approval decision; instead, only a quorum of the members of an approver set need to agree. Additionally, the nature of the processing of the one or more approvers, approver sets or approver groups can be sequential or in parallel. Moreover, approver groups can be arranged in a hierarchy, such that multiple groups from different levels can be required in order to make an approval decision on whether certain security changes can be made.

FIGS. 5A and 5B are flow diagrams of an approval set process 500 according to one embodiment of the invention. The approval set process 500 pertains to processing associated with determining whether a particular approver set has approved or denied a requested security change. The approval set process 500 can, for example, be performed by the approval manager once invoked 412 as shown in FIG. 4A.

The approval set process 500 initially obtains 502 an approver set. The approver set includes one or more members, referred to as “approvers.” Next, a decision 504 determines whether sequential notifications are to be utilized. In this embodiment, the notification to approvers can be achieved sequentially or in parallel, depending on implementation or configuration.

When the decision 504 determines that sequential notifications are not to be utilized, then the approval set process 500 performs parallel notifications. Hence, approval requests are sent 506 to all approvers of the approver set. In one implementation, the approval requests are electronic mail messages that are transmitted to the approvers.

Next, a decision 508 determines whether one or more responses have been received to the approval requests. When the decision 508 determines that no responses have been received, then a decision 510 determines whether a time-out has occurred. When the decision 510 determines that a time-out has occurred (e.g., meaning that adequate numbers of responses have not been received in a timely manner), then approval by the approver set is deemed denied 512. Alternatively, when the decision 510 determines that a time-out has not occurred, then the approval set process 500 returns to repeat the decision 508.

Once the decision 508 determines that one or more responses to the approval request have been received, a decision 514 determines whether approval by a quorum of approvers is no longer possible. For example, if an approver set has five approvers and requires a quorum of three, then if responses from three approvers have already denied approval, then approval by a quorum of approvers is no longer possible. When the decision 514 determines that approval by a quorum of the approvers is no longer possible, then approval by the approver set is denied 512. On the other hand, when the decision 514 determines that approval by a quorum of the approvers is still possible, then a decision 516 determines whether approval by a quorum has been achieved. When the decision 516 determines that approval by a quorum has not been achieved, the approval set process 500 returns to repeat the decision 508 and subsequent blocks so that additional responses can be similarly processed. Alternatively, when the decision 516 determines that approval by a quorum has been achieved, then approval by the approval set is deemed granted 518.

On the other hand, when the decision 504 determines that sequential notifications are to be utilized, then the notifications are sent to the approvers in a sequential fashion. In this regard, a first approver is selected 520 from the approver set. Then, an approval request is sent 522 to the selected approver. Then, a decision 524 determines whether a response has been received from the selected approver. When the decision 524 determines that a response has not yet been received, the approval set process 500 can await such a response (or can time-out or potentially skip the selected approver).

Once the decision 524 determines that a response has been received, a decision 526 determines whether approval by a quorum of the approvers of the approver set is no longer possible. When the decision 526 determines that approval by a quorum of the approvers is no longer possible, then the approval by the approver set is deemed denied 512. Alternatively, when the decision 526 determines that approval by a quorum of the approvers is still possible, then a decision 528 determines whether approval by a quorum of the approvers of the approver set has been achieved. When the decision 528 determines that approval by a quorum has been achieved, approval by the approver set is deemed granted 518.

On the other hand, when the decision 528 determines that approval by a quorum of the approvers of the approver set has not been achieved, a decision 530 determines whether there are more approvers of the approver set to be consulted. When the decision 530 determines that there are more approvers of the approver set to be consulted, the approval set process 500 returns to repeat the decision 520 where a next approver is selected and then similarly processed. Once the decision 530 determines that there are no more approvers to be processed, then the approval by the approver set is deemed denied 512 because approval of a quorum of approvers was not achieved.

The approval of a requested security change can utilize multiple approval sets in order to make an approval decision. Typically, though not necessarily, each set of an approval group would need to approve the requested security change. An approval group can include one or more approval sets.

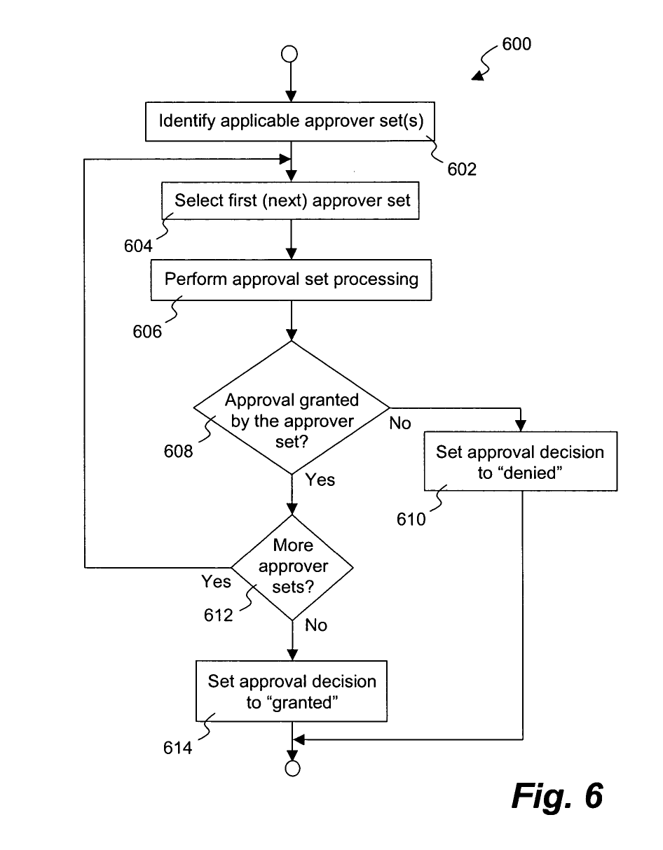

FIG. 6 is a flow diagram of an approval group process 600 according to one embodiment of the invention. The approval group process 600 can be performed by the approval manager once invoked 412 as shown in FIG. 4A. The approval group process 600 is performed for a given approval group.

The approval group process 600 initially identifies 602 one or more applicable approver sets. Here, the applicable approver sets are one or more approver sets that are associated with an approval group being processed. Next, a first approver set is selected 604. Once the approver set is selected, approval set processing is performed 606 for the selected approver set. In one embodiment, the approval set processing being performed 606 is the approval set process 500 discussed above with respect to FIGS. 5A and 5B.

Next, a decision 608 determines whether approval has been granted by the approver set. When the decision 608 determines that approval has not been granted by the approver set, then the approval decision is set 610 to “denied.” On the other hand, when the decision 608 determines that approval has been granted by the approver set, then a decision 612 determines whether there are additional approver sets for the given approval group to be processed. When the decision 612 determines that there are more approver sets to be processed, then a next approver set is selected 604 and similarly processed. Once the decision 612 determines that there are no more approver sets to be processed, the approval decision is set 614 to “granted.”

If the approval decision processing makes use of multiple approval groups, these approval groups can have a hierarchy. The approval groups can be associated with the level within the file security system that the requested security change pertains. For example, a minor or low-level security change may only need approval by a single approval group, but a significant or high-level security change may require approval from a series of approval groups arranged in a hierarchy.

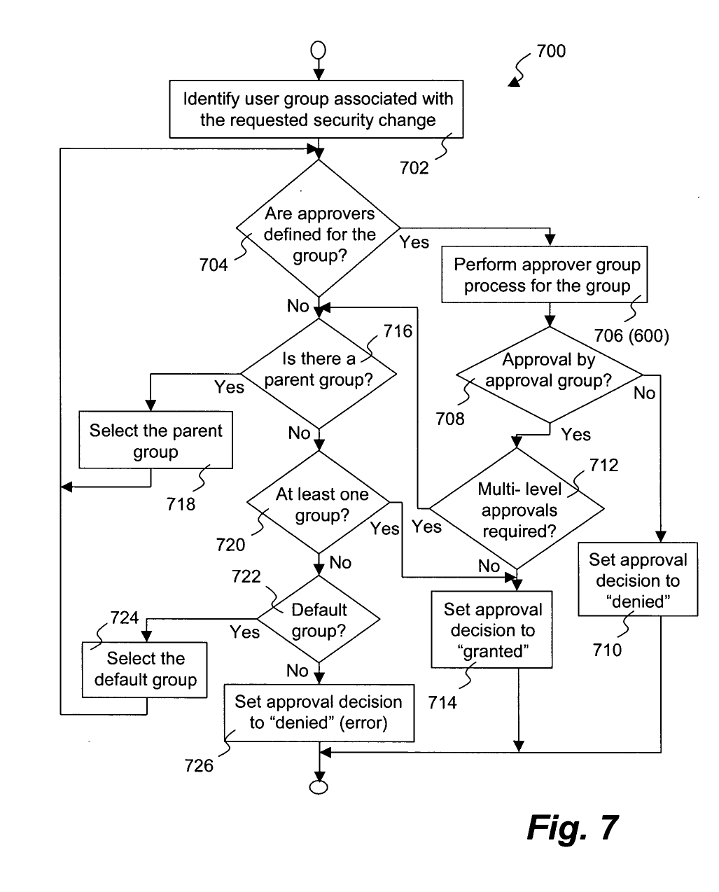

FIG. 7 is a flow diagram of an approval hierarchy process 700 according to one embodiment of the invention. The approval hierarchy process 700 typically involves a plurality of groups arranged in a hierarchy, such that a lower group must first approve the requested security change before a higher group is asked to also approve the requested security change. Further, in order to approve the requested security change, both the lower group and the higher group would need to approve the change.

The approval hierarchy process 700 initially identifies 702 a user group associated with the requested security change. For example, if a requester desired to add a user to an “engineering group,” the requested security change would be associated with the user group referred to as “engineering group.” A decision 704 then determines whether there are approvers defined for the group. The approvers might be one or more or one or more sets of approvers. In any case, when the decision 704 determines that there are approvers defined for the group, then an approval group process is performed 706 for the group. In one implementation, the approval group process can be associated with the approval group process 600 illustrated in FIG. 6. A decision 708 then determines whether the approval group has approved the requested security change. When the decision 708 determines that the approval group has not approved the requested security change, then the approval decision is set 710 to “denied.”

Alternatively, when the decision 708 determines that the approval group has approved the requested security change, then a decision 712 determines whether multi-level approvals are required. Here, the decision 712 determines whether there is an additional level of approval that is still required in order to make the approval decision. When the decision 712 determines that there is another approval level to be processed, then the approval hierarchy process 700 performs a decision 716 that determines whether there is a parent group to the group being processed. Similarly, the decision 716 is performed following the decision 704 when the present group does not have any approvers defined for that group.

When the decision 716 determines that there is a parent group, then the parent group is selected 718. Following the block 718, the approval hierarchy process 700 returns to repeat the decision 704 and subsequent operations so that the newly selected group can be similarly processed.

Alternatively, when the decision 716 determines that there is not a parent group, then a decision 720 determines whether at least one group has been processed. When the decision 720 determines that at least one group has not been processed, then a decision 722 determines whether a default group is present. When the decision 722 determines that there is a default group, then the default group is selected 724. Following the block 724, the approval hierarchy process 700 returns to repeat the decision 704 and subsequent operations so that the newly selected group can be similarly processed.

On the other hand, when the decision 722 determines that there is no default group, then the approval decision is set 726 to “denied” as in this condition, the approval hierarchy process 700 would have an error given that no approver group has been able to be processed.

In addition, when the decision 712 determines that there are no more additional approval levels required to be processed, then an approval decision is set 714 to “granted.” Here, the one or more groups associated with the requested security change to be made have each approved the requested security change and thus the approval decision is set 714 to “granted.” Following the decision 720 when it is determined that least one group has been processed, the approval decision is also set 714 to “granted.”

As noted above, approvers can receive notification of requests to approve or deny requested security changes. These notifications can be delivered as electronic mail messages. In one embodiment, the electronic mail messages can contain a hyperlink or instructions to redirect the approver to a web server. For example, the web server can be a secure web server and require the approver to first log in, and then respond to a prompt to approve or deny a requested security change. In another embodiment, the approvers can reply to electronic mail messages (which used to provide the notifications) so as to provide their decision on whether the requested security change should be approved or denied. The notification can contain information on the specific security being requested, and the response might append thereto an approval and/or denial indication. In one embodiment, the electronic mail notifications and responses can use a markup language to facilitate presentation of appropriate information to approvers as well as to facilitate parsing of the responses by a computer. For example, the markup language can be eXtensible Markup Language (XML). Additionally, a reply message might also include a digital signature of the associated approver so as to validate that the reply message is authenticate and from the approver. Still further, these various electronic mail messages can also be encrypted to secure their contents.

The invention is preferably implemented by software or a combination of hardware and software, but can also be implemented in hardware. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable media can also be distributed over network-coupled computer systems so that the computer readable code is stored and executed in a distributed fashion.

The various embodiments, implementations and features of the invention noted above can be combined in various ways or used separately. Those skilled in the art will understand from the description that the invention can be equally applied to or used in other various different settings with respect to various combinations, embodiments, implementations or features provided in the description herein.

The advantages of the invention are numerous. Different embodiments or implementations may yield one or more of the following advantages. One advantage of the invention is that file security systems are able to prevent bottlenecks that occur with conventional system administrator approvals. Another advantage of the invention is that security changes can be approved in a largely automated manner. Still another advantage of the invention is that a security proxy can manage the approval process for requested security changes. Yet another advantage of the invention is that the approval process is flexible (and possibly hierarchical) so as to be capable of being mapped to a wide range of different organizational structures.

The foregoing description of embodiments is illustrative of various aspects/embodiments of the present invention. Various modifications to the present invention can be made to the preferred embodiments by those skilled in the art without departing from the true spirit and scope of the invention as defined by the appended claims. Accordingly, the scope of the present invention is defined by the appended claims rather than the foregoing description of embodiments.

1. A method for approving a security change for a file security system that secures electronic files, said method comprising:
receiving a requested security change from a requestor;
identifying a plurality of approvers to approve or disapprove of the requested security change;
notifying the approvers of an approval request for the requested security change;
determining whether the requested security change is approved based on responses from the approvers to the approval request; and
performing the requested security change when said determining determines that the requested security change has been approved.

2. A method as recited in claim 1, wherein said notifying of the approvers is achieved by electronic mail.

3. A method as recited in claim 2, wherein the responses from the approval group are provided as electronic mail.

4. A method as recited in claim 1, wherein no one of the plurality of approvers can individually approve the requested security change.

5. A method as recited in claim 1, wherein the plurality of approvers are arranged as a set or group.

6. A method as recited in claim 1, wherein the plurality of approvers are arranged in a plurality of sets or groups, and
wherein said determining requires approval from more than one of the plurality of sets or groups in order to determine that the requested security change is approved.

7. A method as recited in claim 6, wherein the plurality of sets or groups are arranged in a hierarchy, and wherein progression to a next level in the hierarchy requires approval from the set or group associated with a current level.

8. A method as recited in claim 1, wherein the plurality of approvers are users of the file security system.

9. A method as recited in claim 1, wherein the plurality of approvers form a set of approvers, and
wherein said determining determines that the requested security change is approved when a subset of the set of approvers approve the requested security change.

10. A method as recited in claim 1, wherein the plurality of approvers identified by said identifying is dependent on the requested security change.

11. A method as recited in claim 1, wherein the plurality of approvers identified by said identifying is dependent on the requester.

12. A method as recited in claim 1, wherein said notifying operates to substantially simultaneously notify all of the approvers of the approval request for the requested security change.

13. A method as recited in claim 1, wherein said notifying operates to substantially concurrently notify all of the approvers of the approval request for the requested security change.

14. A method as recited in claim 1, wherein the electronic files secured by the file security system are electronic documents.

15. A file security system that restricts access to secured electronic documents, said file security system comprising:
an access server that restricts access to the secured electronic documents; and
an approval manager operatively connected to said access server, said approval manager operates a security change approval process to determine whether a requested security change is approved.

16. A file security system as recited in claim 15, wherein said file security system has one or more system administrators, and wherein said approval manager operates the security change approval process without any interaction from the one or more system administrators.

17. A file security system as recited in claim 15, wherein, in operating the security change approval process, a plurality of approvers are notified of the requested security change and asked to approve or disapprove the requested security change.

18. A file security system as recited in claim 17, wherein the plurality of approvers are notified by notification electronic mail messages.

19. A file security system as recited in claim 18, wherein the plurality of approvers approve or disapprove the requested security change using reply electronic mail messages.

20. A file security system as recited in claim 19, wherein the reply electronic mail messages include a digital signature of the associated approver to verify authenticity.

21. A file security system as recited in claim 17, wherein no one of the approvers can individually approve the requested security change.

22. A file security system as recited in claim 17, wherein the plurality of approvers are arranged as a set or group.

23. A file security system as recited in claim 17, wherein the plurality of approvers are arranged into a plurality of sets or groups, and
wherein said approval manager requires approval from more than one of the plurality of sets or groups in order to determine that the requested security change is approved.

24. A file security system as recited in claim 17, wherein the plurality of sets or groups are arranged in a hierarchy, and wherein progression to a next level in the hierarchy requires approval from the set or group associated with a current level.

25. A file security system as recited in claim 17, wherein the approvers are users of the file security system.

26. A file security system as recited in claim 17, wherein the plurality of approvers form a set of approvers, and
wherein said approval manager determines that the requested security change is approved when a subset of the set of approvers approve the requested security change.

27. A file security system as recited in claim 17, wherein said approval manager identifies the plurality of approvers dependent on the requested security change.

28. A file security system as recited in claim 17, wherein said approval manager identifies the plurality of approvers dependent on the requestor.

29. A file security system as recited in claim 15, wherein said file security system further comprises:
a key store operatively connected to said access server, said key store stores cryptographic keys used to gain access to the secured electronic documents.

30. A computer readable medium including at least computer program code for approving a security change for a file security system that secures electronic files, said computer readable medium comprising:
computer program code for notifying a plurality of approvers of an approval request for the requested security change;
computer program code for determining whether the requested security change is approved based on responses from the approvers to the approval request; and
computer program code for performing the requested security change when said determining determines that the requested security change has been approved.

31. A computer readable medium as recited in claim 30, wherein said notifying of the approvers is achieved by electronic mail.

32. A computer readable medium as recited in claim 31, wherein the responses from the approval group are electronic mail.

33. A computer readable medium as recited in claim 30, wherein no one of the plurality of approvers can individually approve the requested security change.
